(19) United States
(12) Patent Application Publication
(10) Pub. No.: US 2026/0155746 A1
(43) Pub. Date: Jun. 4, 2026

(54) MODE CONTROL CIRCUIT OF CONVERTER AND CONVERTER

(71) Applicant: Joulwatt Technology (Shanghai) Co., Ltd., Shanghai (CN)

(72) Inventors: Linjue LI, Shanghai (CN); Xianzhi MENG, Hangzhou (CN)

(21) Appl. No.: 19/395,285

(22) Filed: Nov. 20, 2025

(30) Foreign Application Priority Data
Dec. 3, 2024 (CN) 202411766844.7

(51) Int. Cl. H02M 3/158

(52) U.S. Cl. CPC H02M 3/1582

(57) ABSTRACT

The present application discloses a mode control circuit of a converter and a converter. The converter comprises an inductor. The mode control circuit comprises: a first voltage detection unit configured to detect and maintain a voltage at both ends of the inductor to obtain a first voltage detection value and a second voltage detection value, a difference value between the first voltage detection value and the second voltage detection value representing the difference between the input terminal voltage and the output terminal voltage of the converter. A control unit is configured to control the operating mode of the converter based on the difference between the first voltage detection value and the second voltage detection value. The present application greatly improves the accuracy of mode control for the converter by optimizing the judgment conditions for mode switching, thereby improving the stability and efficiency of the converter.

### CROSS-REFERENCE TO RELATED APPLICATIONS

This present disclosure claims priority to a Chinese patent application No. 202411766844.7, filed on Dec. 3, 2024, and entitled “Mode Control Circuit of Converter and Converter”, the entire contents of which are incorporated herein by reference, including the specification, claims, drawings and abstract.

### FIELD OF TECHNOLOGY

This application relates to the field of power electronics technology, more particularly, to a mode control circuit of a converter and a converter.

### BACKGROUND

Converters usually can adjust the output voltage to be higher or lower than the input voltage, and they are generally composed of switch transistors, inductors, input capacitors, and output capacitors to form Buck circuits or Boost circuits.

Due to the non-ideal characteristics of devices in the circuit, there are signal jumps during the switching transition between different operating modes, and usually nonlinear control is required to improve the smoothness of the mode switching process. The prerequisite for using nonlinear control is to determine which operating mode the converter should be in and when mode switching is needed.

In related technologies, usually the relationship between input voltage and output voltage is directly used to control mode switching. However, due to the complex characteristics of circuit structure of the converter, it is difficult to achieve effective working mode switching of the converter, which affects the boost and buck effect of the converter.

### SUMMARY

The present application provides a mode control circuit of a converter and a converter, which solves the technical problem of low accuracy of mode switching point determined directly by using the relationship between input voltage and output voltage. By optimizing the judgment conditions for mode switching, the accuracy of mode control for converter is greatly improved, thereby improving the stability and efficiency of the converter.

In order to achieve the above objectives, the main technical solutions adopted in this application include:

In one aspect of the present application, embodiments of the present application provide a mode control circuit of a converter, wherein the converter comprises an inductor, a first end of the inductor is configured to be connected to an input terminal of the converter, and a second end of the inductor is configured to be connected to an output terminal of the converter, the mode control circuit comprising:

a first voltage detection unit, wherein a first detection terminal of the first voltage detection unit is connected to a first terminal of the inductor, and a second detection terminal of the first voltage detection unit is connected to the second terminal of the inductor; the first voltage detection unit is configured to detect and maintain a voltage at both ends of the inductor to obtain a first voltage detection value and a second voltage detection value, wherein the difference value between the first voltage detection value and the second voltage detection value is used to represent the difference between the input voltage of the converter and the output voltage of the converter;
a control unit, which is configured to control the operating mode of the converter based on the difference value between the first voltage detection value and the second voltage detection value, wherein the operating mode of the converter comprises at least one of BOOST mode, BUCK mode, and BUCK BOOST mode.

The mode control circuit proposed in this embodiment achieves real-time monitoring of the voltage difference between the two ends of the inductor during the charging and discharging process by detecting the difference value between the first voltage detection value and the second voltage detection value through the first voltage detection unit, and the control unit controls the working mode of the converter based on the real-time monitoring results, achieving precise switching between the BOOST mode and the BUCK mode of the converter. Therefore, compared with the traditional method of directly using the relationship between input voltage and output voltage for mode switching, embodiments of the present application achieve accurate detection of the difference between the input voltage and output voltage of the converter by the above mode control circuit, effectively eliminating the influence of circuit impedance changes, such as switching on and off, of the switching transistor on the mode switching of the converter, greatly improving the accuracy of determining the mode switching point, which helps to balance the stability and working efficiency of the converter and improve the buck boost effect of the converter.

Optionally, in some embodiments of the present application, the first voltage detection unit is further configured to detect the voltage at both ends of the inductor when the inductor is directly connected to the input terminal and output terminal of the converter.

Optionally, in some embodiments of the present application, the first voltage detection unit is further configured to perform voltage maintaining operation when the inductor is not directly connected between the input terminal and output terminal of the converter; perform voltage detection when the inductor is directly connected between the input terminal and output terminal of the converter.

Embodiments of the present application effectively suppress the interference of the on/off action of the switching transistor in the converter on voltage detection by setting the working process of voltage detection and voltage maintaining for the first voltage detection unit, and improves the accuracy of the voltage detection results of the inductor at both ends by the first voltage detection unit.

Optionally, in some embodiments of the present application, the first voltage detection unit is further configured to,
delay for a first time after entering the state where the inductor is directly connected to the input terminal and output terminal of the converter, and then perform the voltage detection operation, and continuously perform the voltage maintaining operation during the first time.

Embodiment of the present application ensures effective detection of the voltage across the inductor by delaying the setting of voltage detection work for the first time, thereby improving the accuracy of voltage detection.

Optionally, in some embodiments of the present application, the control unit is further configured to: control the converter to exit the BUCK mode when the difference value between the first voltage detection value and the second voltage detection value is less than the first reference value;
control the converter to enter the BUCK mode when the difference value between the first voltage detection value and the second voltage detection value is greater than the sum of the first reference value and the first preset threshold.

Optionally, in some embodiments of the present application, the control unit is further configured to control the converter to exit the BOOST mode when an opposite number of the difference value between the first voltage detection value and the second voltage detection value is less than the second reference value;
control the converter to enter the BOOST mode when the opposite number of the difference value between the first voltage detection value and the second voltage detection value is greater than the sum of the second reference value and the second preset threshold.

In the embodiment of the present application, the comparison result among the voltage difference of the two ends of the inductor, the relevant reference value, and the preset threshold by the control unit is used as the judgment condition for the switching of the working mode of the converter, and thus switching of the working mode of the converter is controlled accurately by the control unit. Compared with traditional methods that directly performing mode switching based on the relationship between input voltage and output voltage, the mode control circuit proposed in the embodiment of the present application can effectively eliminate the interference of circuit impedance change caused by the on resistance of the switching transistor on the mode switching, greatly improving the accuracy of determining the mode switching point, such that the converter switches efficiently between BOOST mode and BUCK mode, which improves the buck boost effect of the converter.

Optionally, in some embodiments of the present application, the mode control circuit further comprises:
a second voltage detection unit, wherein the first detection end of the second voltage detection unit is connected to the first end of the inductor, and the second detection end of the second voltage detection unit is connected to the second end of the inductor; the second voltage detection unit is configured to detect the voltage drop generated by the parasitic resistance of the inductor and send the voltage drop to the control unit.

Embodiment of the present application achieves real-time detection of the voltage drop generated by the parasitic resistance of the inductor, namely the Equivalent Series Resistance (ESR), by setting a second voltage detection unit, thereby eliminating the influence of the voltage drop of the parasitic resistance of the inductor on the mode switching of the converter, and further improving the accuracy of the mode switching point of the converter.

Optionally, in some embodiments of the present application, the control unit is further configured to,
control the converter to exit the BUCK mode when the difference between the difference value of the first voltage detection value and the second voltage detection value and the voltage drop is less than the first reference value;
control the converter to enter the BUCK mode when the difference between the difference value of the first voltage detection value and the second voltage detection value and the voltage drop is greater than the sum of the first reference value and the first preset threshold.

Optionally, in some embodiments of the present application, the control unit is further configured to,
control the converter to exit the BOOST mode when the difference between the voltage drop and the difference value of the first voltage detection value and the second voltage detection value is less than a second reference value;
control the converter to enter the BOOST mode when the difference between the voltage drop and the difference value of the first voltage detection value and the second voltage detection value is greater than the sum of the second reference value and the second preset threshold.

In the embodiments of the present application, the control unit uses the comparison result among the voltage difference at both ends of the inductor, the relevant reference value, and the preset threshold as the judgment condition for switching the working mode of the converter, so as to accurately control the switching of the working mode of the converter. Moreover, the mode control circuit proposed in the embodiments of the present application can effectively eliminate the interference of circuit impedance changes caused by the on resistance of the switch transistor and the ESR of the inductor on the switching of the working mode, which greatly improves the accuracy of determining the mode switching point, and enables the converter to switch efficiently between the BOOST mode and the BUCK mode, thereby improving the buck boost effect of the converter.

Optionally, in some embodiments of the present application, the second voltage detection unit comprises:
a first resistor, one end of which is connected to the first end of the inductor;
a second resistor, one end of which is connected to the second end of the inductor;
a first capacitor, one end of which is connected to the other end of the first resistor and has a first node, and the other end of the first capacitor is grounded;
a second capacitor, one end of which is connected to the other end of the second resistor and has a second node, and the other end of the second capacitor is grounded;
a first differential amplifier, wherein the positive input terminal of the first differential amplifier is connected to the first node, the negative input terminal of the first differential amplifier is connected to the second node, and the output terminal of the first differential amplifier is used to output the voltage drop.

Embodiments of the present application use a circuit structure composed of resistors and capacitors to implement the voltage sampling and holding function of the second voltage detection unit, and combines it with the first differential amplifier to achieve accurate calculation and stable output of the voltage drop detection result, thereby helping the control unit to improve the accuracy of the converter mode switching point by utilizing the detection result output by the first differential amplifier.

Optionally, in some embodiments of the present application, the first voltage detection unit comprises:
a third resistor, one end of which is connected to the first end of the inductor;
a fourth resistor, one end of which is connected to the second end of the inductor;
a third capacitor, one end of which is connected to the other end of the third resistor and has a third node, and the other end of the third capacitor is grounded;
a fourth capacitor, one end of which is connected to the other end of the fourth resistor and has a fourth node, and the other end of the fourth capacitor is grounded;
a first controllable switch, the first end of which is connected to the third node and the second end of which is connected to the fourth node;
a fifth capacitor, one end of which is connected to the third end of the first controllable switch and has a fifth node, and the other end of the fifth capacitor is grounded;
a sixth capacitor, one end of which is connected to the fourth end of the first controllable switch and has a sixth node, and the other end of the sixth capacitor is grounded;
wherein, the fifth node is used to output the first voltage detection value, and the sixth node is used to output the second voltage detection value.

Optionally, in some embodiments of the present application, the first voltage detection unit is configured to,
control the first controllable switch to open when the inductor is not directly connected between the input terminal and the output terminal of the converter, and the first voltage detection unit performs voltage maintaining operation;
control the first controllable switch to close when the inductor is directly connected between the input terminal and the output terminal of the converter, and the first voltage detection unit performs voltage detection work.

Optionally, in some embodiments of the present application, the first voltage detection unit further comprises:
a second controllable switch, wherein the first end of the second controllable switch is connected to the third node, the second end of the second controllable switch is connected to the fourth node, and the third and fourth ends of the second controllable switch are connected to each other and then grounded.

Optionally, in some embodiments of the present application, the first voltage detection unit is configured to,
control the second controllable switch to close for a second time and then open before the first controllable switch is closed, wherein the second controllable switch is open when the inductor is directly connected between the input terminal and output terminal of the converter, and the first controllable switch is delayed for a third time and then closed after the second controllable switch is open.

The first voltage detection unit proposed in the embodiments of the present application cooperates with the on-off action of the first controllable switch to control the charging and discharging states of the third capacitor and the fourth capacitor, and combines the third resistor and the fourth resistor to sample the voltage at both ends of the inductor. Then, the holding of the sampling results is achieved by the fifth capacitor and the sixth capacitor, so as to achieve accurate detection of the voltage at both ends of the inductor and obtain the corresponding first voltage detection value and second voltage detection value. This helps to improve the accuracy of the mode switching point of the converter by using the first voltage detection value and the second voltage detection value subsequently, and actively controls the charging and discharging of the third capacitor and the fourth capacitor through the second controllable switch, which can shorten the delay time and thus improve the detection efficiency.

Optionally, in some embodiments of the present application, the first voltage detection unit further comprises:
a second differential amplifier, wherein the positive input terminal of the second differential amplifier is connected to the fifth node, the negative input terminal of the second differential amplifier is connected to the sixth node, and the output terminal of the second differential amplifier is used to output the difference value between the first voltage detection value and the second voltage detection value.

In the embodiments of the present application, the difference between the first voltage detection value and the second voltage detection value is accurately calculated and output stably through the second differential amplifier, so as to obtain an accurate detection result of the difference between the input terminal voltage of the converter and the output terminal voltage of the converter. This helps the mode control circuit to improve the accuracy of the converter mode switching point by utilizing the detection result output by the second differential amplifier.

Optionally, in some embodiments of the present application, the first voltage detection unit further comprises:
a third controllable switch, wherein the first end of the third controllable switch is connected to the input terminal of the converter, the second end of the third controllable switch is connected to the output terminal of the converter, the third end of the third controllable switch is connected to the fifth node, and the fourth end of the third controllable switch is connected to the sixth node; wherein when the third controllable switch is closed and the first controllable switch is open, the first voltage detection value output by the fifth node is the input terminal voltage of the converter, and the second voltage detection value output by the sixth node is the output terminal voltage of the converter.

Optionally, in some embodiments of the present application, the first voltage detection unit is further configured to control the third controllable switch to close and the first controllable switch to open when an absolute value of the difference value between the voltage at the input terminal of the converter and the voltage at the output terminal of the converter is greater than the preset voltage threshold, or when the converter is in a standby mode or a light load high-efficiency operating mode.

In the present embodiment, a third controllable switch is set in the first voltage detection unit. In the case where the difference between the voltage at the input terminal and the voltage at the output terminal of the converter is too large, and in the case where the converter is in standby mode or light load high-efficiency mode, the third controllable switch is controlled to close and the first controllable switch is controlled to open to ensure effective detection of the mode control circuit, thereby ensuring that the mode control circuit can achieve accurate mode switching in special operating conditions. Therefore, the setting of the third controllable switch improves the adaptability of the mode control circuit in special operating conditions.

Optionally, in some embodiments of the present application, the control unit comprises:
a first subtractor, which is configured to subtract the difference value between the first voltage detection value and the second voltage detection value from the voltage drop to obtain a first calculated value;
a first hysteresis comparator, which is configured to compare the first calculated value with a first reference value to determine whether the converter exits the BUCK mode.

In the embodiments of the present application, the magnitude relationship among the difference value of the first voltage detection value and the second voltage detection value, the voltage drop, and the relevant reference values is compared by the first subtractor and the first hysteresis comparator, so as to control whether the converter exits the BUCK mode based on the comparison result, and to avoid frequent switching of the converter in the BUCK mode through the hysteresis effect of the first hysteresis comparator, thereby improving the stability of the converter.

Optionally, in some embodiments of the present application, the control unit further comprises:
a second subtractor, which is configured to subtract the voltage drop from the difference value between the first voltage detection value and the second voltage detection value to obtain a second calculated value;
a second hysteresis comparator, which is configured to compare the second calculated value with a second reference value to determine whether the converter exits the BOOST mode.

In the embodiments of the present application, the magnitude relationship among the difference value of the first voltage detection value and the second voltage detection value, the voltage drop, and the relevant reference values is compared by the second subtractor and the second hysteresis comparator, so as to control whether the converter exits the BOOST mode based on the comparison result, and to avoid frequent switching of the converter in the BOOST mode through the hysteresis effect of the second hysteresis comparator, thereby improving the stability of the converter.

Optionally, in some embodiments of the present application, the control unit further comprises:
a first adder, which is configured to add the voltage drop, the second voltage detection value, and the first reference value to obtain a third calculated value;
a third hysteresis comparator, which is configured to compare the third calculated value with the first voltage detection value to determine whether the converter exits the BUCK mode.

In the embodiments of the present application, the magnitude relationship among the voltage drop of the inductor, the first voltage detection value, the second voltage detection value, and the relevant reference value is compared by the first adder and the third hysteresis comparator, so as to control whether the converter exits the BUCK mode based on the comparison result, and to avoid frequent switching of the converter in the BUCK mode through the hysteresis effect of the third hysteresis comparator, thereby improving the stability of the converter.

Optionally, in some embodiments of the present application, the control unit further comprises:
a second adder, which is configured to add the voltage drop and the second voltage detection value to obtain a fourth calculated value;
a third adder, which is configured to add the first voltage detection value and the second reference value to obtain a fifth calculated value;
a fourth hysteresis comparator, which is configured to compare the fourth calculated value with the fifth calculated value to determine whether the converter exits the BOOST mode.

In the embodiments of the present application, the magnitude relationship among the voltage drop of the inductor, the first voltage detection value, the second voltage detection value, and the relevant reference value is compared by the second adder, the third adder, and the fourth hysteresis comparator, so as to control whether the converter exits the BOOST mode based on the comparison result, and to avoid frequent switching of the converter in the BOOST mode through the hysteresis effect of the fourth hysteresis comparator, thereby improving the stability of the converter.

In a second aspect, embodiments of the present application provide a converter, comprising:
an inductor;
at least one switch transistor;
the mode control circuit according to the above embodiments.

The converter proposed in the embodiment of the application monitors the voltage difference of the two ends of the inductor in real-time during the charging and discharging process through a mode control circuit, and controls the working mode of the converter based on the real-time monitoring results, achieving precise switching between the BOOST mode and the BUCK mode of the converter. Therefore, compared with the traditional method of directly using the relationship between input voltage and output voltage for mode switching, embodiments of the present application achieve accurate detection of the difference between the input voltage and output voltage of the converter through the above mode control circuit, effectively eliminating the influence of circuit impedance changes, e.g., switching on and off of the switching transistor, on the mode switching of the converter, which greatly improves the accuracy of determining the mode switching point, and facilitates the balance of the stability and working efficiency of the converter, and improves the buck boost effect of the converter.

Optionally, in some embodiments of the present application, the converter is a BOOST converter, a BUCK converter, or a BUCK BOOST converter.

### BRIEF DESCRIPTION OF THE DRAWINGS

In order to describe the specific embodiments of the present application or the technical solutions in the prior art more clearly, a brief introduction will be given to the accompanying drawings required for the specific embodiments or the prior art description. Obviously, the drawings described below are some embodiments of the present application. For those of ordinary skill in the art, other drawings can be obtained based on these drawings without creative efforts.

FIG. 1 is a circuit diagram of the converter in the prior art;

FIG. 2 is a structural diagram of the mode control circuit of the converter proposed by an embodiment of the present application;

FIG. 3 is a structural diagram of the mode control circuit of the converter proposed by another embodiment of the present application;

FIG. 4 is a circuit diagram of the second voltage detection unit proposed by the embodiment of the present application;

FIG. 5 is a circuit diagram of the first voltage detection unit proposed by an embodiment of the present application;

FIG. 6 is a circuit diagram of the first voltage detection unit proposed by another embodiment of the present application;

FIG. 7 is a circuit diagram of the control unit proposed by an embodiment of the application;

FIG. 8 is a circuit diagram of the control unit proposed by another embodiment of the application;

FIG. 9 is a circuit schematic diagram of the control unit proposed by another embodiment of the present application;

FIG. 10 is a circuit diagram of the control unit proposed by another embodiment of the present application;

FIG. 11 is a structural diagram of the converter proposed by an embodiment of the present application.

### DETAILED DESCRIPTION

In order to clarify the purpose, technical solutions, and advantages of the embodiments of the present application, the following will provide a clear and complete description of the technical solution in the embodiments of the present application in conjunction with the accompanying drawings. Obviously, the described embodiments are a part of the embodiments of the present application, not all of them. Based on the embodiments in this application, all other embodiments obtained by those skilled in the art without creative efforts are within the protection scope of this application.

As an important component widely used in power circuits, switching converter can regulate the output voltage to be lower or higher than the input voltage. In related technologies, the circuit topology of a buck boost switching converter of positive voltage output is as shown in FIG. 1. The buck boost switching converter comprises switching transistor Q1, switching transistor Q2, switching transistor Q3, switching transistor Q4, inductor L, and output capacitor C. The output voltage can be adjusted by controlling the duty cycles of the four switching transistors.

Wherein, the buck boost switching converter generally has the following working modes:
When the input voltage V_{IN} is significantly higher than the output voltage V_{OUT}, a BUCK working mode is adopted. In the BUCK working mode, switch transistor Q4 remains on and switch transistor Q3 remains off. The output voltage V_{OUT} is adjusted by adjusting the duty cycle of switch transistor Q1, and the switching states of switch transistors Q2 and Q1 are complementary;
When the input voltage V_{IN} is significantly lower than the output voltage V_{OUT}, the BOOST working mode is adopted. In the BOOST working mode, the switch transistor Q1 remains on and the switch transistor Q2 remains off. The output voltage V_{OUT} is adjusted by adjusting the duty cycle of switch transistor Q3, and the switching states of switch transistors Q4 and Q3 are complementary.

These working modes enable the BUCK boost switching converter to maintain stable output voltage under different input voltage conditions. However, due to the non-ideal characteristics of the device, there are signal jumps during the switching transition of the above operating modes. Generally, nonlinear control needs to be added to improve the smoothness of the mode switching process. Nonlinear control can effectively smooth the mode switching process, while using nonlinear control determines which operating mode the converter should be in and when the mode switching is needed.

In related technologies, mode switching is generally controlled directly by the relationship between input voltage and output voltage. However, due to the complex circuit structure characteristics of the converter, the direct use of input voltage and output voltage is easily affected by load current, switch on resistance, and inductor on resistance. For example, for the buck working mode, the rising slope of inductor current of switch transistor Q1 during the on stage is shown in the following formula (1):

$$\frac{di}{dt} = \frac{{V}_{IN} - {I}_{L} \times ( {R}_{dsQ 1} + {R}_{dsQ 4} + {R}_{ESR} ) - {V}_{OUT}}{L} \qquad formula ( 1 )$$

In the formula,

$$\frac{di}{dt}$$

is the rising slope of the inductor current mentioned above, V_{IN} is the input voltage, V_{OUT} is the output voltage, I_{L} is the inductor current, L is the inductance value, R_{ESR} is the equivalent series resistance (ESR) of the inductor, R_{dsQ1} is the on resistance of switch transistor Q1, and R_{dsQ4} is the on resistance of switch transistor Q4.

In order to ensure that the inductor current reaches this rising slope within the required time, it is required that the input voltage meets the requirements of formula (2) below:

$${V}_{IN} - {I}_{L} \times ( {R}_{dsQ 1} + {R}_{dsQ 4} + {R}_{ESR} ) - {V}_{OUT} > {V}_{TH} \qquad formula ( 2 )$$

In the formula, V_{TH} is a preset limit voltage.

Therefore, the converter needs to exit the buck operation mode when the input voltage V_{IN} is less than I_{L}×(R_{dsQ1}+R_{dsQ4}+R_{ESR})+V_{OUT}+V_{TH}. Thus it can be seen that directly using the relationship between input voltage and output voltage to determine whether to switch modes has the problem of low accuracy, which makes it difficult to achieve effective switching of the working mode of the converter, thereby affecting the boost and buck effect of the converter.

In addition, the duty cycle can also be used as a judging condition for mode switching in related technologies, but this method is easily affected by the working state of the converter, making it difficult to accurately determine the time point of mode switching. For example, during the start-up and dynamic load changes of the converter, its duty cycle will rapidly change, which may result in false triggering of mode switching. In addition, when the converter operates under light load and frequency reduction, the duty cycle is relatively small, which can also lead to errors in the judgment of mode switching.

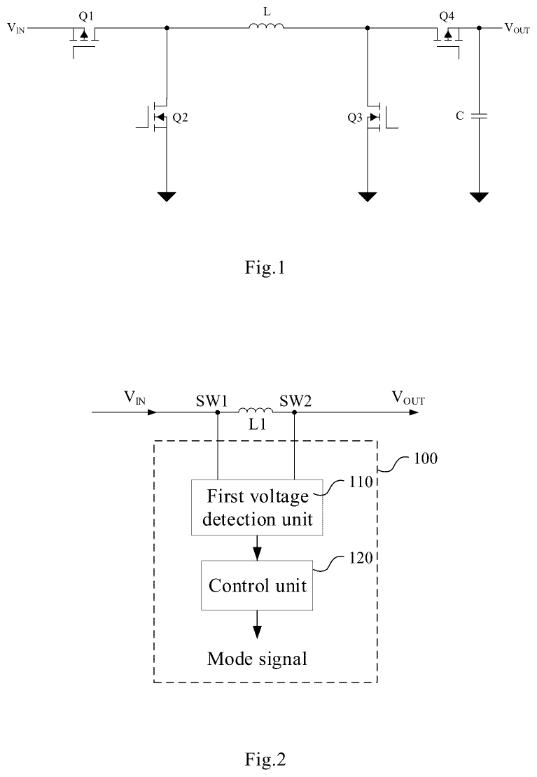

In the embodiment of the present application, a mode control circuit 100 of a converter is provided, and the mode control circuit 100 can be applied to power supply devices with voltage conversion functions such as converters and chargers. As shown in FIG. 2, the mode control circuit 100 comprises an inductor L1, wherein the first end of the inductor L1 is configured to connect to the input terminal of the converter, and the second end of the inductor L1 is configured to connect to the output terminal of the converter. The mode control circuit 100 comprises a first voltage detection unit 110 and a control unit 120.

The first detection terminal SW1 of the first voltage detection unit 110 is connected to the first terminal of the inductor L1, and the second detection terminal SW2 of the first voltage detection unit 100 is connected to the second terminal of the inductor L1. The first voltage detection unit 110 is configured to detect and maintain the voltage at both ends of the inductor L1 to obtain the first voltage detection value V_{SW1_SAM} and the second voltage detection value V_{SW2_SAM}. The difference value V_{SW1_SW2} between the first voltage detection value V_{SW1_SAM} and the second voltage detection value V_{SW2_SAM} is used to represent the difference between the input voltage V_{IN} of the converter and the output voltage V_{OUT} of the converter.

The control unit 120 is configured to control the working mode of the converter based on the difference value V_{SW1_SW2} between the first voltage detection value V_{SW1_SAM} and the second voltage detection value V_{SW2_SAM}, wherein the working mode of the converter comprises at least one of BOOST mode, BUCK mode, and BUCK BOOST mode.

The mode control circuit 100 proposed in the embodiment of the present application achieves real-time monitoring of the voltage difference between the two ends of the inductor L1 during charging and discharging by the difference value V_{SW1_SW2} between the first voltage detection value V_{SW1_SAM} and the second voltage detection value V_{SW2_SAM} detected by the first voltage detection unit 110, and outputs a mode signal through the control unit 120 based on the real-time monitoring results to control the working mode of the converter, achieving precise switching of the converter between the BOOST mode and the BUCK mode.

Specifically, in the case where the difference value between the first voltage detection value V_{SW1_SAM} and the second voltage detection value V_{SW1_SAM} is greater than the first preset voltage value, the control unit 120 controls the working mode of the converter 10 to switch to the BUCK mode. In the case where the difference between the second voltage detection value V_{SW2_SAM} and the first voltage detection value V_{SW1_SAM} is less than the second preset voltage value, the control unit 120 controls the operation mode of the converter 10 to switch to the BOOST mode.

Therefore, embodiments of the present application do not directly detect the voltage at the input terminal and output terminal of the converter, but detect the voltage at the first detection terminal SW1 and the second detection terminal SW2 at both ends of inductor L1, thus effectively eliminating the influence of circuit impedance changes such as on and off of the switching transistor on the mode switching of the converter, achieving accurate detection of the difference between the input voltage and output voltage of the converter, greatly improving the accuracy of determining the mode switching point, balancing the stability and working efficiency of the converter, and improving the buck boost effect of the converter. In some embodiments of the present application, the above first voltage detection unit 110 is further configured to detect the voltage across the inductor L1 when it is directly connected between the input terminal and output terminal of the converter.

Furthermore, the above first voltage detection unit 110 is also configured to perform voltage maintaining operation when the inductor L1 is not directly connected between the input terminal and output terminal of the converter; perform voltage detection when inductor L1 is directly connected between the input terminal and output terminal of the converter.

Wherein, in the case when inductor L1 is directly connected between the input terminal and output terminal of the converter, i.e., switch transistor Q1 and switch transistor Q4 are both in an on state, the first voltage detection unit 110 performs charging work for a period of time to enable the first voltage detection unit 110 to perform voltage detection work to obtain the detection voltage of the first detection terminal SW1 and the second detection terminal SW2. When inductor L1 is not directly connected between the input terminal and output terminal of the converter, i.e., at least one of switch transistor Q1 and switch transistor Q4 is in an off state, the first voltage detection unit 110 performs voltage maintaining operation.

Therefore, embodiments of the present application can effectively suppress the interference of the on-off action of the switching transistor in the converter on voltage detection by setting the voltage maintaining operation and voltage detection operation of the first voltage detection unit 110, improve the accuracy of voltage detection results of the two ends of the inductor L1 by the first voltage detection unit 100, and thus obtain reliable and accurate voltage detection values.

Specifically, in the embodiments of the present application, the above first voltage detection unit 110 is further configured to delay for the first time and then perform the voltage detection operation after entering the state where the inductor L1 is directly connected between the input terminal and output terminal of the converter, and continuously perform the voltage maintaining operation within the first time.

Embodiment of the present application ensures that the voltage rises to meet the detection requirements by the setting of delaying for the first time then performing the voltage detection work, and this ensures that the first detection unit achieves effective detection of the voltage at both ends of the inductor, thereby improving the accuracy of voltage detection.

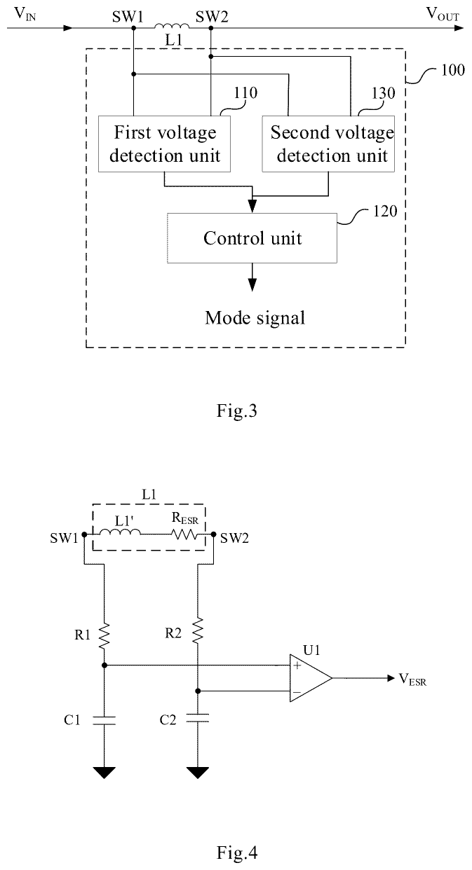

In some embodiments of the present application, as shown in FIG. 3, the above mode control circuit 100 further comprises a second voltage detection unit 130, wherein the first detection terminal SW1 of the second voltage detection unit 130 is connected to the first terminal of the inductor L1, and the second detection terminal SW2 of the second voltage detection unit 130 is connected to the second terminal of the inductor L1. The second voltage detection unit 130 is configured to detect the voltage drop generated by the parasitic resistance of the inductor L1 and send the voltage drop to the control unit 120.

Embodiment of the present application achieves real-time detection of the voltage drop caused by the parasitic resistance of inductor L1, namely the Equivalent Series Resistance (ESR), by setting up a second voltage detection unit 130, thereby eliminating the influence of the voltage drop of the inductor on the mode switching of the converter, and further improving the accuracy of mode switching point of the converter.

In some embodiments of the present application, as shown in FIG. 4, the above second voltage detection unit 130 comprises a first resistor R1, a second resistor R2, a first capacitor C1, a second capacitor C2, and a first differential amplifier U1; wherein one end of the first resistor R1 is connected to the first end SW1 of the inductor L1, one end of the second resistor R2 is connected to the second end SW2 of the inductor L1, and one end of the first capacitor C1 is connected to the other end of the first resistor R1 and has a first node; the other end of the first capacitor C1 is grounded, one end of the second capacitor C2 is connected to the other end of the second resistor R2 and has a second node. The other end of the second capacitor C2 is grounded. The positive input terminal of the first differential amplifier U1 is connected to the first node, and the negative input terminal of the first differential amplifier U1 is connected to the second node. The output terminal of the first differential amplifier U1 is used to output the voltage drop V_{ESR}.

It should be noted that FIG. 4 shows the inductance L′ of inductor L1 and the equivalent series resistance R_{ESR} of inductor L1. In fact, inductance L′ and the equivalent series resistance R_{ESR} represent inductor L1 as a whole.

In some embodiments of the present application, it may set that R1=R2 and C1=C2, and if the resistance and capacitance satisfy the following formula (3):

$$\frac{{L}^{′}}{{R}_{ESR}} = R 1 \cdot C 1 \qquad formula ( 3 )$$

then the output voltage of the first differential amplifier U1 is completely in phase with the voltage drop generated by the parasitic resistance R_{ESR} of the inductor.

Embodiment of the present application utilizes a circuit structure composed of resistors and capacitors to implement the voltage sampling and holding function of the second voltage detection unit 130, and uses the first differential amplifier U1 to calculate the difference between the voltage of the first node and the voltage of the second node, so as to achieve accurate calculation and stable output of the voltage drop detection result. This helps the control unit 120 to improve the accuracy of the converter mode switching point by using the detection result V_{ESR} output by the first differential amplifier U1.

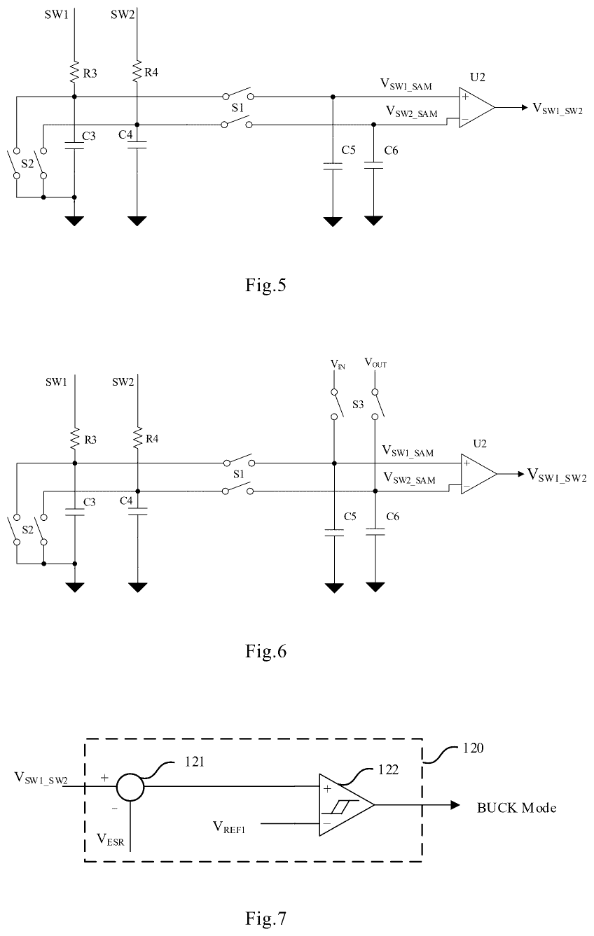

In some embodiments of the present application, as shown in FIG. 5, the above first voltage detection unit 110 comprises a third resistor R3, a fourth resistor R4, a third capacitor C3, a fourth capacitor C4, a first controllable switch S1, a fifth capacitor C5, and a sixth capacitor C6. Wherein, one end of the third resistor R3 is connected to the first end SW1 of the L1 inductor, one end of the fourth resistor R4 is connected to the second end SW2 of the inductor L1, one end of the third capacitor C3 is connected to the other end of the third resistor R3 and has a third node, and the other end of the third capacitor C3 is grounded; one end of the fourth capacitor C4 is connected to the other end of the fourth resistor R4 and has a fourth node. The other end of the fourth capacitor C4 is grounded. The first end of the first controllable switch S1 is connected to the third node, and the second end of the first controllable switch S1 is connected to the fourth node. One end of the fifth capacitor C5 is connected to the third end of the first controllable switch S1 and has a fifth node, and the other end of the fifth capacitor C5 is grounded. One end of the sixth capacitor C6 is connected to the fourth end of the first controllable switch S1 and has a sixth node, and the other end of the sixth capacitor C6 is grounded.

Wherein, the fifth node is used to output the first voltage detection value V_{SW1_SAM}, and the sixth node is used to output the second voltage detection value V_{SW2_SAM}.

Furthermore, in some embodiments of the present application, the voltage detection and voltage maintaining processes of the first voltage detection unit 110 are specifically described as follows:
In the case where inductor L1 is not directly connected between the input terminal and output terminal of the converter, that is, at least one of switch transistor Q1 and switch transistor Q4 of the converter is in the off state, the first controllable switch S1 is controlled to open, and the first voltage detection unit 110 performs voltage maintaining operation;
In the case where the inductor L1 is directly connected between the input terminal and output terminal of the converter, that is, the switching transistor Q1 and the switching transistor Q4 of the converter are both in the on state, the first controllable switch S1 is controlled to close, and the first voltage detection unit 110 performs voltage detection work.

It should be noted that in some embodiments of the present application, the first controllable switch S1 is controlled to delay the first time and then is closed after both the switch transistor Q1 and switch transistor Q4 are turned on, in order to ensure that the voltages of the third capacitor C3 and the fourth capacitor C4 rise to meet the detection requirements when the first controllable switch S1 is closed.

In other embodiments of the present application, the first voltage detection unit 110 further comprises a second controllable switch S2, wherein the first end of the second controllable switch S2 is connected to the above third node, the second end of the second controllable switch S2 is connected to the above fourth node, and the third and fourth ends of the second controllable switch S2 are connected to each other and then grounded.

By the above setting of the second controllable switch S2, it is possible to actively control the charging and discharging of the third capacitor C3 and the fourth capacitor C4, thereby shortening the delay time to improve the voltage detection efficiency.

Specifically, the first voltage detection unit 110 is configured to:

Before the first controllable switch S1 is closed, control the second controllable switch S2 to close for a second time and then open, wherein the second controllable switch S2 is open when the inductor L1 is directly connected between the input terminal and output terminal of the converter, and the first controllable switch S1 is delayed for a third time and then closed after the second controllable switch S2 is open.

Embodiments of the present application actively control the third capacitor C3 and the fourth capacitor C4 to discharge by closing the second controllable switch S2 for a second time. It should be noted that the second controllable switch S2 can be closed at the moment when both switch transistor Q1 and switch transistor Q4 start to conduct, or at any time when at least one of switch transistor Q1 and switch transistor Q4 is in the off state.

In addition, the present embodiment sets the first controllable switch S1 to delay for a third time and then close after the second controllable switch S2 is open, which can ensure that the third capacitor C3 and the fourth capacitor C4 maintain a charging state for a period of time, thereby ensuring that after the voltage of the third capacitor C3 and the fourth capacitor C4 rises to meet the detection requirements, and then close the first controllable switch S1 for voltage detection.

For example, when the second controllable switch S2 is closed and the first controllable switch S1 is open, the third capacitor C3 and the fourth capacitor C4 are in a discharge state and discharged to zero level, while the fifth capacitor C5 and the sixth capacitor C6 maintain the sampling voltage of the previous detection cycle.

After the second time is elapsed, the second controllable switch S2 is open and the first controllable switch S1 is kept open. At this time, the third capacitor C3 and the fourth capacitor C4 are in a charging state, and the charging time constant is R3*C3. In the embodiments of the present application, the duration of keeping the first controllable switch S1 open and the second controllable switch S2 open can be set to 4 times or more the charging time constant, i.e., a minimum duration of 4*R3*C3.

After the third time is elapsed, the second controllable switch S2 remains open, the first controllable switch S1 is closed, and the first voltage detection unit 110 performs voltage detection work. Due to the closure of the first controllable switch S1, the voltage of the fifth capacitor C5 is equal to the voltage of the third capacitor C3, and the voltage of the sixth capacitor C6 is equal to the voltage of the fourth capacitor C4. Therefore, the detected first voltage detection value V_{SW1_SAM} and second voltage detection value V_{SW2_SAM} are shown in the following formulas (4) and (5):

$${V}_{SW 1 \_ SAM} = {V}_{IN} - {I}_{L} \times {R}_{dsQ 1} \qquad formula ( 4 )$$

$${V}_{SW 2 \_ SAM} = {V}_{OUT} + {I}_{L} \times {R}_{dsQ 4} \qquad formula ( 5 )$$

In the formulas, V_{IN} is the input voltage of the converter, V_{OUT} is the output voltage of the converter, I_{L} is the inductor current, R_{dsQ1} is the on resistance of the switching transistor Q1, and R_{dsQ4} is the on resistance of the switching transistor Q4. It should be noted that in the circuit structure of the first voltage detection unit shown in FIG. 5, the voltage divider effect of the third resistor R3 and the fourth resistor R4 can be ignored since their resistance values are very small.

In addition, due to the unavoidable parasitic inductance and capacitance in actual circuits, these parasitic inductance and capacitance can cause non-ideal behavior of the first terminal SW1 and the second terminal SW2. Therefore, in the circuit structure shown in FIG. 5, the third resistor R3, the third capacitor C3, the fourth resistor R4, and the fourth capacitor C4 can suppress high-frequency power oscillations at the first terminal SW1 and the second terminal SW2 after the switching transistor is turned on and off in the converter.

Subsequently, when the second controllable switch S2 is open and the first controllable switch S1 is open, the first voltage detection unit 110 performs voltage maintaining operation. Since the first controllable switch S1 is open, the fifth capacitor C5 and the sixth capacitor C6 maintain the voltage at the time of the first controllable switch S1 until the next detection cycle.

The first voltage detection unit 110 proposed in the embodiment of the present application controls the charging and discharging states of the third capacitor C3 and the fourth capacitor C4 by coordinating the on/off actions of the first controllable switch S1 and the second controllable switch S2. It also samples the voltage across the inductor L1 by combining the third resistor R3 and the fourth resistor R4, and maintains the sampling results through the fifth capacitor C5 and the sixth capacitor C6, to achieve accurate detection of the voltage across the inductor L2 and obtains the corresponding first voltage detection value V_{SW1_SAM} and second voltage detection value V_{SW2_SAM}, which helps to improve the accuracy of the converter mode switching point by using the first voltage detection value V_{SW1_SAM} and the second voltage detection value V_{SW2_SAM} in the future.

In some embodiments of the present application, as shown in FIG. 5, the first voltage detection unit 110 further comprises a second differential amplifier U2, wherein the positive input terminal of the second differential amplifier U2 is connected to the fifth node, the negative input terminal of the second differential amplifier U2 is connected to the sixth node, and the output terminal of the second differential amplifier U2 is used to output the difference value V_{SW1_SW2} between the first voltage detection value V_{SW1_SAM} and the second voltage detection value V_{SW2_SAM}.

The difference value V_{SW1_SW2} between the first voltage detection value V_{SW1_SAM} and the second voltage detection value V_{SW2_SAM} is calculated by using the second differential amplifier U2, and the output voltage of the second differential amplifier U2 is shown in the following formula (6):

$${V}_{SW 1 \_ SAM} = {V}_{IN} - {V}_{OUT} - {I}_{L} \times {R}_{dsQ 1} - {I}_{L} \times {R}_{dsQ 4} \qquad formula ( 6 )$$

Thus it can be seen that the present embodiment accurately calculates and stably output the difference value between the first voltage detection value V_{SW1_SAM} and the second voltage detection value V_{SW2_SAM} through the second differential amplifier U2. Compared with directly using the relationship between the input voltage and the output voltage for mode switching, the difference value V_{SW1_SW2} output by the first voltage detection unit 110 can more accurately represent the difference between the input voltage and the output voltage of the converter, thereby providing a more accurate judgment basis for determining the mode switching point and effectively eliminating the influence of circuit impedance changes, such as switching on and off of the switching transistor, on the mode switching of the converter.

In one embodiment of the present application, the voltage across inductor L1 is detected by the first voltage detection unit 110, and the control unit 120 controls the switching of the buck boost mode of the converter based on the detection result.

Specifically, in some embodiments of the present application, the control unit 120 is also configured to:

When the difference value between the first voltage detection value V_{SW1_SAM} and the second voltage detection value V_{SW2_SAM} is less than the first reference value V_{REF1}, the control converter exits the BUCK mode. That is, when the detection result of the first voltage detection unit 110 satisfies the following formula (7), the control unit 120 controls the converter to exit the BUCK mode:

$${V}_{SW 1 \_ SAM} - {V}_{SW 2 \_ SAM} < {V}_{REF 1} \qquad formula ( 7 )$$

When the difference value between the first voltage detection value V_{SW1_SAM} and the second voltage detection value V_{SW2_SAM} is greater than the sum of the first reference value V_{REF1} and the first preset threshold V_{TH1}, the converter is controlled to enter the BUCK mode. That is, when the detection result of the first voltage detection unit 110 satisfies the following formula (8), the control unit 120 controls the converter to enter the BUCK mode:

$${V}_{SW 1 \_ SAM} - {V}_{SW 2 \_ SAM} > {V}_{REF 1} + {V}_{TH 1} \qquad formula ( 8 )$$

When the opposite number of the difference value between the first voltage detection value V_{SW1_SAM} and the second voltage detection value V_{SW2_SAM} is less than the second reference value V_{REF2}, the converter is controlled to exit the BOOST mode. That is, when the detection result of the first voltage detection unit 110 satisfies the following formula (9), the control unit 120 exits the BOOST mode:

$${V}_{SW 2 \_ SAM} - {V}_{SW 1 \_ SAM} > {V}_{REF 2} \qquad formula ( 9 )$$

When the opposite number of the difference value between the first voltage detection value V_{SW1_SAM} and the second voltage detection value V_{SW2_SAM} is greater than the sum of the second reference value and the second preset threshold, the converter is controlled to enter BOOST mode. That is, when the detection result of the first voltage detection unit 110 satisfies the following formula (10), the control unit 120 controls the converter to enter BOOST mode:

$${V}_{SW 2 \_ SAM} - {V}_{SW 1 \_ SAM} > {V}_{REF 2} + {V}_{TH 2} \qquad formula ( 10 )$$

Therefore, in the embodiments of the present application, the control unit uses the comparison result between the voltage difference between the two ends of the inductor, the relevant reference value, and the preset threshold as the judging condition for switching the working mode of the converter, so as to accurately control the switching of the working mode of the converter. Compared with traditional methods that directly perform mode switching based on the relationship between input voltage and output voltage, the mode control circuit proposed in this embodiment can effectively eliminate the interference of circuit impedance changes caused by the on resistance of the switching transistor on the mode switching, greatly improving the accuracy of determining the mode switching point, thereby enabling the converter to switch efficiently between the BOOST mode and the BUCK mode, and improving the buck boost effect of the converter.

In other embodiments of the present application, the voltage across inductor L1 is detected by the first voltage detection unit 110 and combined with the second voltage detection unit 120 to detect the voltage drop V_{ESR} caused by the parasitic resistance of inductor L1, thereby eliminating the influence of the voltage drop caused by the parasitic resistance of inductor on the mode switching of the converter, and further improving the accuracy of the mode switching point of the converter.

Specifically, in other embodiments of the present application, the mode control of the converter by control unit 120 is as follows:

When the difference between the difference value of the first voltage detection value V_{SW1_SAM} and the second voltage detection value V_{SW2_SAM} and the voltage drop V_{ESR} is less than the sum of the first reference value V_{REF1}, the converter is controlled to exit the BUCK mode. That is, when the detection results of the first voltage detection unit 110 and the second detection unit 130 satisfy the following formula (11), the control unit 120 will control the converter to exit the BUCK mode:

$${V}_{SW 1 \_ SW 2} - {V}_{ESR} = {V}_{IN} - {V}_{OUT} - {I}_{L} \times ( {R}_{dsQ 1} + {R}_{dsQ 4} + {R}_{ESR} ) < {V}_{REF 1} \qquad formula ( 11 )$$

When the difference between the difference value of the first voltage detection value V_{SW1_SAM} and the second voltage detection value V_{SW2_SAM} and the voltage drop V_{ESR} is greater than the sum of the first reference value V_{REF1} and the first preset threshold V_{TH1}, the converter is controlled to enter the BUCK mode. That is, when the detection results of the first voltage detection unit 110 and the second detection unit 130 satisfy the following formula (12), the control unit 120 controls the converter to enter the BUCK Mode:

$${V}_{SW 1 \_ SW 2} - {V}_{ESR} = {V}_{IN} - {V}_{OUT} - {I}_{L} \times ( {R}_{dsQ 1} + {R}_{dsQ 4} + {R}_{ESR} ) > {V}_{REF 1} + {V}_{TH 1} \qquad formula ( 12 )$$

When the difference between the voltage drop V_{ESR} and the difference value V_{SW1_SW2} of the first voltage detection value V_{SW1_SAM} and the second voltage detection value V_{SW2-SAM} is less than the second reference value V_{REF2}, the converter is controlled to exit the BOOST mode. That is, when the detection results of the first voltage detection unit 110 and the second detection unit 130 satisfy the following formula (13), the control unit 120 controls the converter to exit BOOST mode:

$${V}_{ESR} - {V}_{SW 1 \_ SW 2} = {V}_{OUT} + {I}_{L} \times ( {R}_{dsQ 1} + {R}_{dsQ 4} + {R}_{ESR} ) - {V}_{IN} < {V}_{REF 2} \qquad formula ( 13 )$$

In the case where the difference between the voltage drop V_{ESR} and the difference value V_{SW1_SW2} of the first voltage detection value V_{SW1_SAM} and the second voltage detection value V_{SW2_SAM} is greater than the sum of the second reference value V_{REF2} and the second preset threshold V_{TH2}, the converter is controlled to enter the BOOST mode, i.e., in the case where the detection results of the first voltage detection unit 110 and the second detection unit 130 satisfy the following formula (14), the control unit 120 will control the converter to exit the BOOST mode:

$${V}_{ESR} - {V}_{SW \_ 1 , SW \_ 2} = {V}_{OUT} + {I}_{L} \times ( {R}_{dsQ 1} + {R}_{dsQ 4} + {R}_{ESR} ) - {V}_{IN} > {V}_{REF 2} + {V}_{TH 2} \qquad formula ( 14 )$$

Embodiment of the present application uses the control unit 120 to accurately control the switching of the working mode of the converter by comparing the difference voltage between the two ends of the inductor L1, the voltage drop, the relevant reference value, and the preset threshold as the judging condition for switching the working mode of the converter. Compared with the traditional methods that directly perform mode switch based on the relationship between input voltage and output voltage, the mode control circuit 100 proposed in the embodiment of the present application can effectively eliminate the interference of circuit impedance changes caused by the on resistance of the switch transistor and inductance ESR on the mode switching, which greatly improves the accuracy of determining the mode switching point and enables the converter to efficiently switch between the BOOST mode and the BUCK mode, thereby improving the buck boost effect of the converter.

In some embodiments of the present application, as shown in FIG. 6, the first voltage detection unit 110 further comprises a third controllable switch S3, wherein the first end of the third controllable switch S3 is connected to the input terminal of the converter, the second end of the third controllable switch S3 is connected to the output terminal of the converter, the third end of the third controllable switch S3 is connected to the fifth node, and the fourth end of the third controllable switch S3 is connected to the sixth node; wherein, when the third controllable switch S3 is closed and the first controllable switch S1 is open, the first voltage detection value V_{SW1_SAM} output by the fifth node is the input voltage of the converter, and the second voltage detection value V_{SW2_SAM} output by the sixth node is the output voltage of the converter.

Furthermore, the first voltage detection unit 110 is further configured to control the third controllable switch S3 to close and the first controllable switch S1 to open when the absolute value of the difference value between the input voltage of the converter and the output voltage of the converter is greater than the preset voltage threshold;

And, when the converter is in the standby mode or light load high-efficiency mode, the third controllable switch S3 is controlled to close and the first controllable switch S1 is controlled to open.

Specifically, there may be some special working conditions of the converter; for example, the converter will temporarily stop the working state of the switch under light load and high efficiency conditions or standby conditions. Still for example, in the case where the input voltage and output voltage differ significantly, the turn-on time of switch transistor Q1 and switch transistor Q4 is very short. However, the first voltage detection unit 110 needs to discharge, charge, detect and maintain voltage during the time when switch transistor Q1 and switch transistor Q4 are simultaneously turned on in order to complete the voltage detection work. Therefore, the shorter turn-on time is not enough to allow the first detection terminal SW1 and the second detection terminal SW2 to reach a stable state and perform voltage sampling. For these special working conditions, embodiments of the present application directly sample the input voltage V_{IN} and output voltage V_{OUT} of the converter by setting a third controllable switch S3 to shorten the voltage detection time. It should be noted that under these special working conditions, the inductance current is very small or the input and output voltages differ greatly. The on resistance of the switch transistor and the direct current resistance (DCR) voltage drop of the inductance have little impact on the mode judgment, which can be ignored here.

Therefore, in the embodiments of the present application, a third controllable switch S3 is set in the first voltage detection unit. In the case where the difference value between the input voltage and the output voltage of the converter is too large, and in the case where the converter is in standby mode or light load high-efficiency mode, the third controllable switch S3 is controlled to close and the first controllable switch S1 is controlled to open to ensure effective detection of the mode control circuit 100, thereby ensuring that the mode control circuit 100 can achieve accurate mode switching under special working conditions. Therefore, the setting of the third controllable switch S3 improves the adaptability of the mode control circuit 100 under special conditions.

In some embodiments of the present application, if only the detection result of the first voltage detection unit 110 is used to determine whether to exit the BUCK mode, the difference value V_{SW1_SAM} between the first voltage detection value V_{SW1_SAM} and the second voltage detection value V_{SW2_SAM} and the first reference value V_{REF1} are directly sent to the input terminal of the first hysteresis comparator 122 for comparison.

In some other embodiments of the present application, if the detection results of the first voltage detection unit 110 and the second detection unit 130 are used to determine whether to exit the BUCK mode, as shown in FIG. 7, the control unit 120 comprises a first subtraction unit 121 and a first hysteresis comparator 122. The first subtraction unit 121 is configured to subtract the difference value V_{SW1_SW2} between the first voltage detection value V_{SW1_SAM} and the second voltage detection value V_{SW2_SAM} from the voltage drop V_{ESR} to obtain a first calculated value. The first hysteresis comparator 122 is configured to compare the first calculated value with the first reference value V_{REF1} to determine whether the converter exits the BUCK mode.

Specifically, controller 120 is set according to above formula (11). If the first calculated value is less than the first reference value V_{REF1}, the first hysteresis comparator 122 outputs a mode signal to exit BUCK Mode.

Therefore, in the embodiment of the present application, the difference value V_{SW1_SW2} of the voltage at two ends of inductor L1, the voltage drop V_{ESR}, and the magnitude relationship between the relevant reference values are compared by the first adder 121 and the first hysteresis comparator 122, so as to control whether the converter exits the BUCK mode based on the comparison results, and to avoid frequent switching of the converter in the BUCK mode through the hysteresis effect of the first hysteresis comparator 122, thereby improving the stability of the converter.

In some embodiments of the present application, if only the detection result of the first voltage detection unit 110 is used to determine whether to exit the BOOST mode, the difference value V_{SW1_SAM} between the first voltage detection value V_{SW1_SAM} and the second voltage detection value V_{SW2_SAM}, and the second reference value V_{REF2} are directly sent to the input terminal of the first hysteresis comparator 124 for comparison.

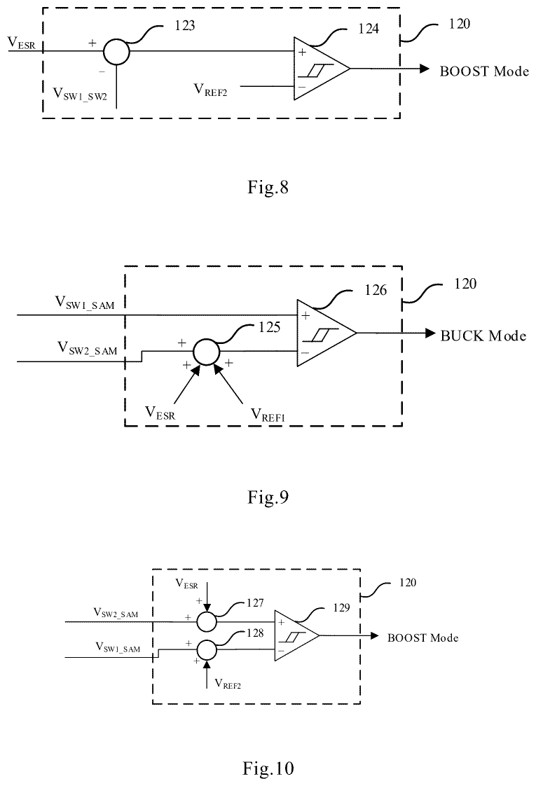

In some other embodiments of the present application, if it is determined whether to exit the BOOST mode by using the detection results of the first voltage detection unit 110 and the second detection unit 130, as shown in FIG. 8, the control unit 120 further comprises a second subtraction device 123 and a second hysteresis comparator 124, wherein the second subtraction device 123 is configured to subtract the voltage drop V_{ESR} from the difference value V_{SW1_SW2} between the first voltage detection value V_{SW1_SAM} and the second voltage detection value V_{SW2_SAM} to obtain a second calculated value, and the second hysteresis comparator 124 is configured to compare the second calculated value with the second reference value V_{REF2} to determine whether the converter exits the BOOST mode.

Specifically, controller 120 is set according to above formula (13). If the second calculated value is less than the second reference value V_{REF2}, the second hysteresis comparator 124 outputs a mode signal to exit the BOOST mode.

Therefore, in the embodiment of the application, the difference value V_{SW1_SW2} in voltage between the two ends of inductor L1, voltage drop V_{ESR}, and the magnitude relationship between the relevant reference values are compared by the second subtractor 123 and the second hysteresis comparator 124, so as to control whether the converter exits the BOOST mode based on the comparison result, and to avoid frequent switching of the converter in the BOOST mode through the hysteresis effect of the second hysteresis comparator, thereby improving the stability of the converter.

In some embodiments of the present application, as shown in FIG. 9, the control unit 120 further comprises a first adder 125 and a third hysteresis comparator 126, wherein the first adder 125 is configured to add the voltage drop V_{ESR}, the second voltage detection value V_{SW2_SAM}, and the first reference value V_{REF1} to obtain a third calculated value, and the third hysteresis comparator 126 is configured to compare the third calculated value with the first voltage detection value V_{SW1_SAM} to determine whether the converter exists the BUCK mode.

Specifically, since in the embodiment, V_{SW1_SW2}=V_{SW1_SAM}−V_{SW2_SAM}, the above formula (11) can also be transformed into the following formula (15):

$${V}_{SW 1 \_ SAM} < {V}_{REF 1} + {V}_{SW 2 \_ SAM} + {V}_{ESR} \qquad formula ( 15 )$$

Controller 120 is set according to above formula (15). If the third calculated value is greater than the first voltage detection value V_{SW1_SAM}, the third hysteresis comparator 126 outputs a mode signal to exit BUCK mode.

Therefore, in the embodiment of the present application, the first adder 125 and the third hysteresis comparator 126 are used to compare the magnitude relationship among the V_{ESR} of the inductor, the first voltage detection value V_{SW1_SAM}, the second voltage detection value V_{SW2_SAM}, and the relevant reference values, so as to control whether the converter exits the BUCK mode based on the comparison results. The hysteresis effect of the third hysteresis comparator 126 is further used to avoid frequent switching of the converter in the BUCK mode, thereby improving the stability of the converter.

In some embodiments of the present application, as shown in FIG. 10, the control unit 120 further comprises a second adder 127, a third adder 128, and a fourth hysteresis comparator 129, wherein the second adder 127 is configured to add the voltage drop V_{ESR} and the second voltage detection value V_{SW2_SAM} to obtain a fourth calculated value; the third adder 128 is configured to add the first voltage detection value V_{SW1_SAM} and the second reference value V_{REF2} to obtain a fifth calculated value; the fourth hysteresis comparator 129 is configured to compare the fourth calculated value with the fifth calculated value to determine whether the converter exits the BOOST mode.

Specifically, since in the present embodiment V_{SW1_SW2}=V_{SW1_SAM}−V_{SW2_SAM}, the above formula (11) can be transformed into the following formula (16):

$${V}_{ESR} + {V}_{SW 2 \_ SAM} < {V}_{REF 2} + {V}_{SW 1 \_ SAM} \qquad formula ( 16 )$$

Controller 120 is set according to above formula (16). If the fourth calculated value is less than the fifth calculated value, the third hysteresis comparator 126 outputs a mode signal to exit the BOOST mode.

Therefore, in the embodiments of the present embodiment, the second adder 127, the third adder 128, and the fourth hysteresis comparator 129 are used to compare the magnitude relationship among the voltage drop V_{ESR} of the inductor, the first voltage detection value V_{SW1_SAM}, the second voltage detection value V_{SW2_SAM}, and relevant reference values, so as to control whether the converter exits the BOOST mode based on the comparison results, and to avoid frequent switching of the converter in the BOOST mode through the hysteresis effect of the fourth hysteresis comparator 129, thereby improving the stability of the converter.

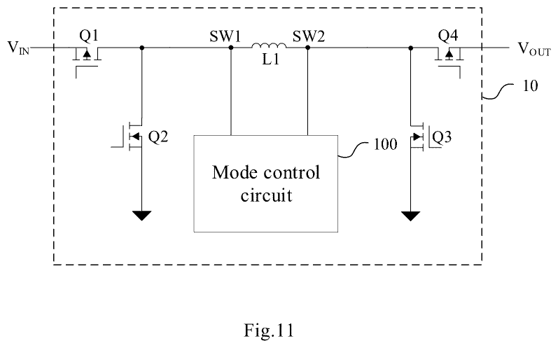

Correspondingly, as shown in FIG. 11, embodiments of the present application provides a converter 10, which comprises an inductor L1, at least one switching transistor, and a mode control circuit 100 according to the above embodiment.

Wherein, in some embodiments of the present application, converter 10 is a BOOST converter, a BUCK converter, or a BUCK BOOST converter.

Converter 10 comprises switch transistor Q1, switch transistor Q2, switch transistor Q3, and switch transistor Q4. If the converter is a BOOST converter, switch transistor Q1 remains on and switch transistor Q2 remains off. The output voltage V_{OUT} is adjusted by adjusting the duty cycle of switch transistor Q3, and the switching states of switch transistor Q4 and switch transistor Q3 are complementary. If the converter is a BUCK converter, switch transistor Q4 remains on and switch transistor Q3 remains off. The output voltage V_{OUT} is adjusted by adjusting the duty cycle of switch transistor Q1, and the switching states of switch transistor Q2 and switch transistor Q1 are complementary.

Therefore, the converter 10 proposed in the embodiment of the present application monitors in real-time the voltage difference between the two ends of the inductor L1 during the charging and discharging process through the mode control circuit, and controls the working mode of the converter 10 based on the real-time monitoring results, achieving precise switching between the BOOST mode and the BUCK mode of the converter 10. Therefore, compared with the traditional method of directly using the relationship between input voltage and output voltage for mode switching, embodiment of the present application achieves accurate detection of the difference between the input voltage and output voltage of the converter 10 through the mode control circuit 100 described above, effectively eliminating the influence of circuit impedance changes such as switching on and off of the switching transistor on the mode switching of the converter, greatly improving the accuracy of determining the mode switching point, balancing the stability and efficiency of the converter, and improving the buck boost effect of the converter.

The descriptions of the further functions of the above modules and units are the same as those in the corresponding embodiments, and will not be repeated here.

For convenience of description, the above devices are divided into various functional units and described separately. Of course, the functions of each unit can be implemented in the same or multiple software and/or hardware when implementing the present application.

It should be noted that the terms “comprise”, “contain”, or any other variation thereof are intended to encompass non-exclusive inclusion, such that a process, method, good, or equipment that includes a series of elements not only contains those elements, but also contains other elements that are not explicitly listed or are inherent to such a process, method, good, or equipment. Without further limitations, the element defined by the statement ‘including one . . . ’ does not exclude the existence of other identical elements in the process, method, product, or device that includes the element in question.

The various embodiments in this specification are described in a progressive manner, and the same and similar parts between each embodiment can be referred to each other. Each embodiment focuses on the differences from other embodiments.

The above description is only an embodiment of the present application and is not intended to limit the present application. For those skilled in the art, this application may have various modifications and variations. Any modifications, equivalent substitutions, improvements, etc. made within the spirit and principles of this application shall be included within the scope of the claims of this application.

Although the embodiments of the present application have been described in conjunction with the accompanying drawings, those skilled in the art may make various modifications and variations without departing from the spirit and scope of the present application, and such modifications and variations fall within the scope defined by the appended claims.

What is claimed is:

1. A mode control circuit of a converter, wherein the converter comprises an inductor, a first end of the inductor is configured to be connected to an input terminal of the converter, and a second end of the inductor is configured to be connected to an output terminal of the converter, the mode control circuit comprising:
a first voltage detection unit, wherein a first detection terminal of the first voltage detection unit is connected to a first terminal of the inductor, and a second detection terminal of the first voltage detection unit is connected to a second terminal of the inductor; the first voltage detection unit is configured to detect and maintain voltages at both ends of the inductor to obtain a first voltage detection value and a second voltage detection value, wherein a difference value between the first voltage detection value and the second voltage detection value is used to represent the difference between an input voltage of the converter and an output voltage of the converter;
a control unit, configured to control an operating mode of the converter based on the difference value between the first voltage detection value and the second voltage detection value, wherein the operating mode of the converter comprises at least one of BOOST mode, BUCK mode, and BUCK BOOST mode.

2. The mode control circuit of claim 1, wherein the first voltage detection unit is further configured to detect the voltage at both ends of the inductor while the inductor is directly connected to the input terminal and output terminal of the converter.

3. The mode control circuit of claim 1, wherein the first voltage detection unit is further configured to,
perform voltage maintaining operation when the inductor is not directly connected between the input terminal and output terminal of the converter;
perform voltage detection when the inductor is directly connected between the input terminal and output terminal of the converter.

4. The mode control circuit of claim 3, wherein the first voltage detection unit is further configured to delay for a first time after entering a state where the inductor is directly connected to the input terminal and output terminal of the converter, and then perform the voltage detection operation, and continuously perform the voltage maintaining operation during the first time.

5. The mode control circuit of claim 1, wherein the control unit is further configured to:
control the converter to exit the BUCK mode while the difference value between the first voltage detection value and the second voltage detection value is less than a first reference value;
control the converter to enter the BUCK mode while the difference value between the first voltage detection value and the second voltage detection value is greater than the sum of the first reference value and the first preset threshold.

6. The mode control circuit of claim 1, wherein the control unit is further configured to,
control the converter to exit the BOOST mode while an opposite number of the difference value between the first voltage detection value and the second voltage detection value is less than the second reference value;
control the converter to enter the BOOST mode while the opposite number of the difference value between the first voltage detection value and the second voltage detection value is greater than the sum of the second reference value and the second preset threshold.

7. The mode control circuit of claim 1, wherein the mode control circuit further comprises:
a second voltage detection unit, wherein a first detection end of the second voltage detection unit is connected to the first end of the inductor, and a second detection end of the second voltage detection unit is connected to the second end of the inductor; the second voltage detection unit is configured to detect voltage drop generated by parasitic resistance of the inductor and send the voltage drop to the control unit.

8. The mode control circuit of claim 7, wherein the control unit is further configured to,
control the converter to exit the BUCK mode while the difference between the difference value of the first voltage detection value and the second voltage detection value and the voltage drop is less than a first reference value;
control the converter to enter the BUCK mode while the difference between the difference value of the first voltage detection value and the second voltage detection value and the voltage drop is greater than the sum of the first reference value and the first preset threshold.

9. The mode control circuit of claim 7, wherein the control unit is further configured to,
control the converter to exit the BOOST mode while the difference between the voltage drop and the difference value of the first voltage detection value and the second voltage detection value is less than a second reference value;
control the converter to enter the BOOST mode while the difference between the voltage drop and the difference value of the first voltage detection value and the second voltage detection value is greater than the sum of the second reference value and the second preset threshold.

10. The mode control circuit of claim 7, wherein the second voltage detection unit comprises:
a first resistor, one end of which is connected to the first end of the inductor;
a second resistor, one end of which is connected to the second end of the inductor;
a first capacitor, one end of which is connected to the other end of the first resistor and has a first node, and the other end of the first capacitor is grounded;
a second capacitor, one end of which is connected to the other end of the second resistor and has a second node, and the other end of the second capacitor is grounded;
a first differential amplifier, wherein a positive input terminal of the first differential amplifier is connected to the first node, a negative input terminal of the first differential amplifier is connected to the second node, and an output terminal of the first differential amplifier is used to output the voltage drop.

11. The mode control circuit of claim 1, wherein the first voltage detection unit comprises:
a third resistor, one end of which is connected to the first end of the inductor;
a fourth resistor, one end of which is connected to the second end of the inductor;
a third capacitor, one end of which is connected to the other end of the third resistor and has a third node, and the other end of the third capacitor is grounded;
a fourth capacitor, one end of which is connected to the other end of the fourth resistor and has a fourth node, and the other end of the fourth capacitor is grounded;
a first controllable switch, the first end of which is connected to the third node and the second end of which is connected to the fourth node;
a fifth capacitor, one end of which is connected to the third end of the first controllable switch and has a fifth node, and the other end of the fifth capacitor is grounded;
a sixth capacitor, one end of which is connected to the fourth end of the first controllable switch and has a sixth node, and the other end of the sixth capacitor is grounded;
wherein, the fifth node is used to output the first voltage detection value, and the sixth node is used to output the second voltage detection value.

12. The mode control circuit of claim 11, wherein the first voltage detection unit is configured to,
control the first controllable switch to open when the inductor is not directly connected between the input terminal and the output terminal of the converter, and the first voltage detection unit performs voltage maintaining operation;
control the first controllable switch to close when the inductor is directly connected between the input terminal and the output terminal of the converter, and the first voltage detection unit performs voltage detection work.

13. The mode control circuit of claim 11, wherein the first voltage detection unit further comprises:
a second controllable switch, wherein a first end of the second controllable switch is connected to the third node, a second end of the second controllable switch is connected to the fourth node, and a third end and a fourth end of the second controllable switch are connected to each other and then grounded.

14. The mode control circuit of claim 13, wherein the first voltage detection unit is configured to,
control the second controllable switch to close for a second time and then open before the first controllable switch is closed, wherein the second controllable switch is open when the inductor is directly connected between the input terminal and output terminal of the converter, and the first controllable switch is delayed for a third time and then closed after the second controllable switch is open.

15. The mode control circuit of claim 11, wherein the first voltage detection unit further comprises:
a second differential amplifier, wherein a positive input terminal of the second differential amplifier is connected to the fifth node, a negative input terminal of the second differential amplifier is connected to the sixth node, and an output terminal of the second differential amplifier is used to output the difference value between the first voltage detection value and the second voltage detection value.

16. The mode control circuit according to claim 11, wherein the first voltage detection unit further comprises:
a third controllable switch, wherein a first end of the third controllable switch is connected to the input terminal of the converter, a second end of the third controllable switch is connected to the output terminal of the converter, a third end of the third controllable switch is connected to the fifth node, and a fourth end of the third controllable switch is connected to the sixth node; wherein while the third controllable switch is closed and the first controllable switch is open, the first voltage detection value output by the fifth node is the input terminal voltage of the converter, and the second voltage detection value output by the sixth node is the output terminal voltage of the converter.

17. The mode control circuit of claim 16, wherein the first voltage detection unit is further configured to,
control the third controllable switch to close and the first controllable switch to open while an absolute value of the difference value between the voltage at the input terminal of the converter and the voltage at the output terminal of the converter is greater than the preset voltage threshold, or while the converter is in a standby mode or a light load high-efficiency operating mode.

18. The mode control circuit of claim 7, wherein the control unit comprises:
a first subtractor, configured to subtract the difference value between the first voltage detection value and the second voltage detection value from the voltage drop to obtain a first calculated value;
a first hysteresis comparator, configured to compare the first calculated value with a first reference value to determine whether the converter exits the BUCK mode.

19. The mode control circuit of claim 7, wherein the control unit further comprises:
a second subtractor, configured to subtract the voltage drop from the difference value between the first voltage detection value and the second voltage detection value to obtain a second calculated value;
a second hysteresis comparator, configured to compare the second calculated value with a second reference value to determine whether the converter exits the BOOST mode.

20. The mode control circuit of claim 7, wherein the control unit further comprises:
a first adder, configured to add the voltage drop, the second voltage detection value, and the first reference value to obtain a third calculated value;
a third hysteresis comparator, configured to compare the third calculated value with the first voltage detection value to determine whether the converter exits the BUCK mode.

21. The mode control circuit of claim 7, wherein the control unit further comprises:
a second adder, configured to add the voltage drop and the second voltage detection value to obtain a fourth calculated value;
a third adder, configured to add the first voltage detection value and the second reference value to obtain a fifth calculated value;
a fourth hysteresis comparator, configured to compare the fourth calculated value with the fifth calculated value to determine whether the converter exits the BOOST mode.

22. A converter, wherein comprising:
an inductor;
at least one switch transistor;
the mode control circuit of claim 1.

23. The converter of claim 22, wherein the converter is a BOOST converter, a BUCK converter, or a BUCK BOOST converter.
